(19) United States
(12) Patent Application Publication
(10) Pub. No.: US 2005/0247574 A1
(43) Pub. Date: Nov. 10, 2005

(54) Electrochemical gas detection apparatus and method comprising a permeable membrane and an aqueous electrolyte

(76) Inventor: Mark Sinclair Varney, Lymington (GB)

Correspondence Address: ARNOLD & FERRERA, L.L.P., Suite 630, 2401 Fountainview, Houston, TX, 77057, US

(21) Appl. No.: 11/058,084

(22) Filed: Dec. 9, 2004

(30) Foreign Application Priority Data
Jun. 25, 2002 (GB) 0214611.6

(51) Int. Cl. G01N 27/26

(52) U.S. Cl. 205/783; 204/431; 205/786

(57) ABSTRACT

A method for the electrochemical detection of carbon dioxide, which comprises causing at least a portion of the carbon dioxide to pass through a permeable membrane and dissolve in an aqueous electrolyte containing a metal ion and an organic ligand to form in situ in the electrolyte an equilibrium between the dissolved carbon dioxide species, the metal ion and the ligand concentrations and measuring the varying metal ion concentration and hence calculating the corresponding carbon dioxide concentration by means of measuring a current passing between electrodes present in the electrolyte. Also a gas detection apparatus comprising a housing, a gas permeable membrane, an aqueous electrolyte inside the housing with electrodes. The concentration of the gas is determined amperometrically.

This invention relates to gas detection methods and apparatus and, more particularly, to such methods and apparatus for the detection and measurement of carbon dioxide concentrations in air or in other gas mixtures.

An ability to detect and measure the concentration of carbon dioxide in the atmosphere or in other gas mixtures is required in a variety of applications in different industries. Numerous techniques are currently available and used including infrared absorption, gas chromatography and mass spectrometry.

Of these, the most practical techniques is probably infrared spectroscopy; however, the apparatus required is expensive and requires frequent recalibration.

Gas chromatography is an excellent technique for separating carbon dioxide from other gases and measuring the individual concentrations by, for example, flame ionisation detection or thermal conductivity; however, this technique is also expensive and does not measure in real time.

Mass spectrometry ionises the different gas molecules in an ultra-high vacuum environment which are then varyingly attracted by an electric and/or magnetic field towards a detector, usually in the form of an electron multiplier. This technique is again expensive and generally limited to laboratory use.

All other above techniques generally require expensive and technically complicated instrumentation. They also require specially trained personnel for their operation and maintenance.

A further difficulty is to ensure that the known techniques are specific to the measurement of the concentration of a selected component, in this case carbon dioxide, of a gas mixture.

Although redox-sensitive gases such as oxygen, hydrogen, chlorine, carbon monoxide and nitrogen dioxide can be detected by means of gas-solid interactions based on the redox reactions, for example by surface electronic conductivity sensors (including Taguichi—type sensors) or electro-motive force (emf) sensors based on overall redox reactions, many other gases including carbon dioxide, ammonia and water vapour are relatively inactive with regard to reduction or oxidation reactions and therefore such techniques cannot be used to good effect.

Being an acidic gas, carbon dioxide may theoretically be detected by techniques making use of change to the physical or chemical properties of liquid solutions upon absorption of carbon dioxide therein. Such techniques are, however, not suitable for commercial application.

There is therefore a need for a new technique for the measurement of carbon dioxide concentrations which is less complicated and less expensive than currently available techniques.

In the health care industry in particular, there is a need to measure the carbon dioxide concentration in the exhaled breaths of patients. For example, capnography methods in which a capnogram curve is obtained by continuously recording the carbon dioxide partial pressure in a sample of exhaled breath may be employed as a good indication of whether a patient's lungs are healthy or whether there is a manifestation of asthma and its severity. Such methods employ one of the carbon dioxide measuring techniques described above and therefore include complicated and expensive apparatus; the methods are therefore generally restricted to hospital use.

However, there have been proposals to improve existing capnography methods for such purpose and embody them in small scale apparatus such that the apparatus may be operated and used by patients in the home and elsewhere.

Such proposals have been disclosed, for example, in European Patent Application No. 0 699 414 in the name of The BOC Group pic in the form of a disease management system which comprises means to measure the carbon dioxide concentration in the expiratory flow exhaled from the lungs of a patient and the rate of change of the concentration, and processing means for comparing the results of the measurement with reference data in order to indicate the state of health of the patient, in particular the probability of an impending asthma attack.

Implementation of these proposals for an improved disease management system is dependent on the availability of a new carbon dioxide measurement technique which satisfies the above stated need and which is sufficiently small, reliable and inexpensive to be incorporated in to a miniaturised disease management system for use in the home in particular.

The invention is concerned with the provision of a new carbon dioxide measurement method and apparatus which generally satisfies this need.

In accordance with the invention, there is provided a method for the electrochemical detection of carbon dioxide, which comprises causing at least a portion of the carbon dioxide to pass through a permeable membrane and dissolve in an aqueous electrolyte containing a metal ion and an organic ligand to form in situ in the electrolyte an equilibrium between the dissolved carbon dioxide species, the metal ion and the ligand concentrations and measuring the varying metal ion concentration and hence calculating the corresponding carbon dioxide concentration by means of measuring a current passing between electrodes present in the electrolyte

The amount of carbon dioxide passing through the membrane and hence measured will generally be proportional to the partial pressure of carbon dioxide in the gas stream impinging on the membrane.

The permeable membrane must allow the carbon dioxide to pass through it with minimum impedance. The membrane material is advantageously selected such that it selectively allows the carbon dioxide to pass through it whilst impeding the flow of other gases. The physical properties of the membrane including its thickness are also relevant to the flow of gases therethrough.

In preferred embodiments of the invention, the electrolyte is in contact with the membrane so that the carbon dioxide flows through the membrane and directly in to the electrolyte. In such embodiments, the membrane, whilst allowing a ready flow of carbon dioxide, should also be such that it impedes the flow of water, ie aqueous electrolyte, so as to minimise loss of electrolyte by osmosis or general leakage.

Overall, therefore, the membrane generally should be physically sufficiently thin to allow the passage of carbon dioxide gas in particular in order to allow the detection method to respond rapidly with changing carbon dioxide concentration impinging on the membrane.

However, the membrane should also be thick enough to provide sufficient mechanical strength to prevent or at least minimise loss of aqueous electrolyte.

Selection of membrane material is therefore critical to the method of the invention. Preferred materials exhibiting a high degree of carbon dioxide permeability and selectivity are polymethylpentane (TPX), cellulose acetate (Cellulose), polyethylene, polytetrafluoroethylene (PTFE), polypropylene and polycarbonate.

For overall performance in the method of the invention, including water retention properties, TPX, polyethylene, PTFE and polypropylene are most preferred.

The membrane may usefully have a thickness of 1 to 20 μm. If necessary, the membrane may be supported by an open grid made of a material, normally non-electrically conducting, and attached to the walls of a housing in which the method is conducted.

The basis of the electrochemical method of the invention is the dissolution of the carbon dioxide in to the aqueous electrolyte in the presence of the metal ions and the organic ligands and form an equilibrium therebetween. With regard to the electrolyte, this is water based (aqueous) and is preferably deionised water. A small concentration of a dissolved salt, for example potassium chloride may be added to increase the conductivity of the electrolyte and thereby facilitate the response of the method.

The volume of electrolyte needs to be sufficiently large so that the ions/ligands contained therein can be adjusted in the vicinity of the electrodes in particular to reflect the changing concentration of the dissolved carbon dioxide species present during the method of the invention.

The metal ion present in the electrolyte must be capable of being readily dissolved and ionisable in the aqueous electrolyte. They are advantageously selected from the lowest in the Irving Williams electrochemical series, ie ones having low reduction-oxidation (“redox”) potentials, for example copper, lead, cadmium and zinc. Of these copper is most preferred.

The organic ligand present in the electrolyte must be capable of forming a complex with the metal ion. The ligand may usefully be selected from diamines and dicarboxylic acids. The former type of ligand is preferred and can advantageously be diaminopropane in particular.

In simple terms, the electrochemistry of the method of the invention involves the carbon dioxide dissolving in the aqueous electrolyte to form carbonic acid (H₂CO₃) which then dissociates to release a proton (H⁺) and form hydrogen carbonate (HCO₃⁻). If the pH of the electrolyte is sufficiently high, the hydrogen carbonate can further dissociate to release another proton and form carbonate (CO₃²⁻).

The overall equilibrium reactions can be represented as follows:
CO₂(gas)+H₂O [symbol] H₂CO₃ [symbol] H⁺+HCO₃⁻ [symbol] H⁺+CO₃²⁻

It should be recognised that this represents a series of reactions with a number of equilibrium constants which define each step and control the equilibria. Generally, as more carbon dioxide dissolves, there tends to be an increasing concentration of protons.

Within the electrolyte, the presence of the organic ligand (L) also allows the dissociation of protons. For the preferred divalent metal ion/ligand system, this can be represented as follows:
LH₂ [symbol] LH⁻+H⁺ [symbol] L²⁻+H⁺

The presence of the metal (M) ions in the electrolyte causes an equilibrium reaction with the protonated organic ligand which can be represented as follows:
LH²+M²⁺ [symbol] LM+2H⁺

The dissociated protons from the dissolution of the carbon dioxide interact in both of the above reactions. The quantity of carbon dioxide which is dissolved in the electrolyte can be followed by measuring the quantity of the metal ion that is not complexed with the ligand.

Overall, the carbon dioxide concentration being dissolved in the electrolyte is directly related to the concentration of free metal ions in the electrolyte. The precise relationship between the carbon dioxide concentration and the free metal ion concentration is complex (not linear) but can be theoretically modelled in ways known per se by skilled electrochemists. The modelling generally involves developing an algorithm which considers each step in the series of “competitive” equilibria identified above.

The necessary concentrations of the metal ion and organic ligand in the electrolyte to allow the reactions/equilibria to occur can be determined by the chemical of the above reactions using their known equilibrium constants and to ensure that the correct stoichiometric levels of metal ion and organic ligand are present.

The method of the invention can therefore be “tuned” to respond to a wide range of carbon dioxide concentrations by adjusting the concentrations of individual species and/or selecting ligands with different equilibrium constants.

As stated above, the method of the invention measures the concentration of the (free) metal ions present in the electrolyte in order for the concentration of the dissolved carbon dioxide species (and hence the carbon dioxide concentration itself) to be calculated.

This is achieved by having a “working” electrode and a “counter” electrode present in the electrolyte, establishing an electric potential between them, for example by applying a voltage to the counter electrode and earthing (grounding) the working electrode, and measuring the electric current passing through the electrolyte from the counter electrode to the working electrode. The electrodes may be operated at a constant potential difference, or the potential difference may be periodically “pulsed” between a “rest” position when no reaction with the metal ions occurs and the reaction potential.

The electrodes themselves may be made of any suitable material which does not react with the electrolyte, for example gold or platinum.

The electrodes should be kept within the electrolyte as physically close to the surface of the membrane as possible so that the distance the carbon dioxide gas (and the dissolved carbon dioxide species) passes through the electrolyte to the working electrode is as short as possible.

In preferred embodiments, the electrolyte is adjacent the membrane surface and the electrodes, especially the working electrode (about which the electrochemical reactions tend to occur), are as close as possible to the membrane surface to enable the optimum response in the method of the invention to changes in the carbon dioxide gas concentrations in a gas stream impinging on the other side of the membrane.

The invention also provides gas detection apparatus comprising a housing made of non-electrically conducting material and having a permeable membrane adapted so that gas to be detected is in equilibrium across the membrane to the other side, means for holding a volume of aqueous electrolyte on the other side of the membrane, electrodes positioned within the electrolyte volume adapted to have a potential difference applied therebetween and means to measure, in use of the application, an electric current passing between the electrodes.

The housing is preferably of tubular shape with one open end and one closed end and with the membrane positioned across the housing at or near its open end such that (substantially) all the gas passing in to the apparatus housing must pass through the membrane from one side to the other side.

One the other side of the membrane, the apparatus is adapted to hold a volume of electrolyte close to, and preferably adjacent to, the membrane surface so that, in use, gas passing through the membrane passes quickly in to the electrolyte. In cases in which the electrolyte is designed to be adjacent (and in contact with) the membrane, the membrane itself can be the component acting in conjunction with the housing to keep the electrolyte volume in place.

In preferred embodiments, the membrane may be stretch fitted across the open end of the housing and secured in place with suitable fitting component(s).

The electrodes, usually two, must be positioned within the electrolyte volume and are preferably as close to the membrane surface as possible. The “working” electrode (about which the electrochemical reactions tend to occur) should in particular be as close to the membrane as practicable for optimum apparatus sensitivity to changing carbon dioxide compositions.

In preferred embodiments, the electrodes are supported on a suitable substrate, for example ceramics, plastics, glass, sintered non-electrically conducting materials, etc. As such, the electrodes may be formed on the substrate by “printing” techniques including thick film screen printing and other printing processes including those utilising ultra-violet curable printing inks.

The electrode substrate is advantageously porous so that it may position the electrodes very close to the membrane surface whilst allowing electrolyte to permeate through the pores to and from an electrolyte “reservoir” on the side of the substrate remote from the membrane.

Such a porous substrate may be formed from a porous, sintered body or may be an apertured sheet material made, for example, from the materials listed above. One or more apertures or perforations may be employed. In the case of annularly arranged electrodes as described below, a small number of apertures, for example one, may be positioned in the supporting substrate at the centre of the array.

Alternatively, a number of “micro” or “point” electrodes may be formed on the substrate in a circular (disc) or line array. Such an array is especially useful for the “working” electrode and makes the apparatus more responsive generally. With such electrodes, the apparatus may work on a steady state basis.

In other embodiments, one or both of the electrodes may be formed, for example printed, on the surface of the membrane adjacent the electrolyte; in such embodiments, there clearly could not be any gap between the membrane surface and the electrolyte.

In the most preferred case, the electrodes (2) are formed in a single plane as an array of interleaved concentric annular portions. These are preferably formed on a thin substrate with one or more apertures therethrough at the centre of the array.

Means to apply an electric potential between the electrodes and means to measure a current flowing between the electrodes in use of the apparatus of the invention can be included in ways known to the skilled electrochemist. Electrical connections with the electrodes will generally pass through the housing and the electrical circuitry be positioned outside the housing.

It has been found that the methods and apparatus of the invention are particularly suitable for use in a disease management system, especially one in which the concentration of the carbon dioxide in the exhaled breath of a patient can be employed to predict and/or detect an impending asthma attack including the one described above with specific reference to European Patent Application No. 0 699 414. A disease management system having incorporated therein the methods and/or apparatus of the invention is specifically included in the ambit of this invention overall.

For a better understanding of the invention, reference will now be made, by way of exemplification only, to the accompanying drawings in which:

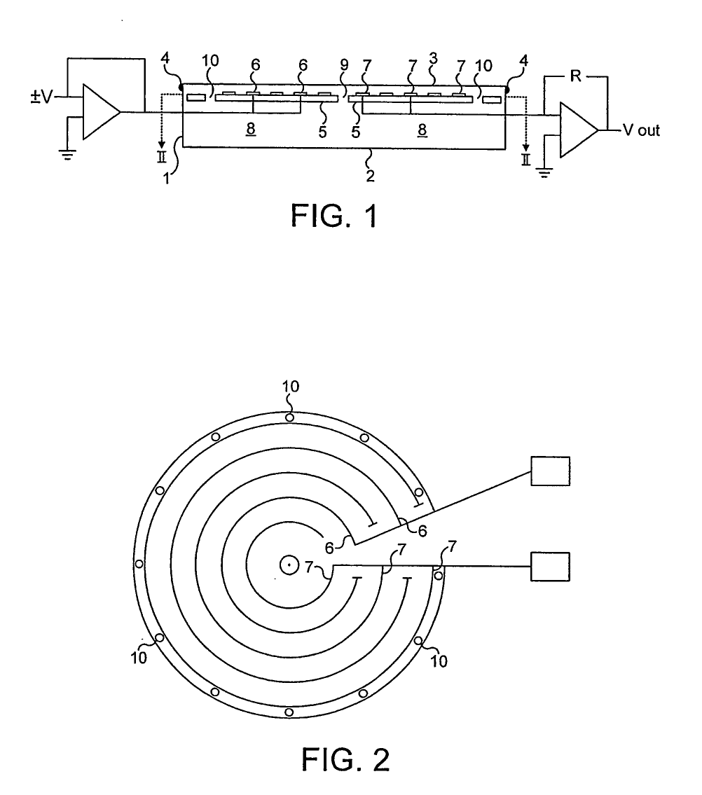

FIG. 1 is a schematic representation of an apparatus of the invention for carrying out a method of the invention, and

FIG. 2 is a sectional view along the line II-II of FIG. 1 showing the electrode construction in particular.

With reference to the drawings and to FIG. 1 in particular, there is shown a gas detection apparatus comprising a tubular housing 1 having a closed end 2 and made from an electrically insulating plastic material. A membrane 3 in the form of a thin sheet of polypropylene is stretched across the other end of the housing 1 and secured around its periphery by means of a hoop 4.

A circular electrode substrate 5 made of an electrically insulating material is positioned in the housing 1 (by means not shown) such that its upper (as shown) surface is close to the membrane 3.

Screen printed on to the surface of the electrode substrate 5 are two electrodes in the form of an array of two interleaved concentric annular portions 6, 7 each of which is connected to electrical circuitry outside the housing 1.

The shape and configuration of the electrode portions 6, 7 are shown in FIG. 2.

In use of the apparatus in carrying out a method of the invention, an aqueous electrolyte is placed in the inside of the housing 1 so that it is in contact with the membrane 3, covers the electrode portions 6, 7 and fills a reservoir 8 “behind” the electrode substrate 5. A central aperture 9 in the electrode substrate 5 and further holes 10 around the periphery of the electrode substrate 5 allows for movement of the electrolyte to and from the reservoir 8 so that changing compositions of electrolyte can be accommodated.

The electrode portions 6, 7 are connected to an electronic “potentiostat” circuit which applies a voltage to the counter electrode portion 6 and, in use, measures the current passing through the electrolyte to the other, working electrode portion 7.

The current to be measured is converted to a voltage (Ohm's law) using a resistor R. It will generally be small and therefore careful attention to the electronic design and detail is necessary.

The electrodes may be operated at a constant potential difference or alternatively the potential difference may be pulsed between a rest position (when no reaction with the metal ion present in the electrolyte) and the reaction potential.

The potential difference causes a current to pass between the electrodes when the voltage is equal to (or greater than) the reaction potential of the metal ion. As stated above, the current is converted to a voltage and is recorded as a function of the carbon dioxide concentration detected by the apparatus.

The apparatus responds optimally by pulsing the potential difference (usually “square wave voltammetry”). Measurement of the response several times during each pulse can also be effected in order to assess the performance of the sensor, the sensor chemistry and of the electronics.

1. A method for the electrochemical detection of carbon dioxide, which comprises causing at least a portion of the carbon dioxide to pass through a permeable membrane and dissolve in an aqueous electrolyte containing a metal ion and an organic ligand to form in situ in the electrolyte an equilibrium between the dissolved carbon dioxide species, the metal ion and the ligand concentrations and measuring the varying metal ion concentration and hence calculating the corresponding carbon dioxide concentration by means of measuring a current passing between electrodes present in the electrolyte.

2. A method according to claim 1 in which the electrolyte is in contact with the membrane.

3. A method according to claim 1 or claim 2 in which the membrane is one of TPX, polyethylene, PTFE and polypropylene.

4. A method according to any preceding claim in which the metal ion is a copper ion.

5. A method according to any preceding claim in which the ligand is one of a diamine and a dicarboxylic acid.

6. A method according to claim 5 in which the ligand is diaminopropane.

7. A method according to any preceding claim in which the electrodes are operated at a constant potential difference.

8. A method according to any one of claims 1 to 6 in which the electrodes are operated with a pulsed potential difference between a “rest” position in which no reaction with the metal ions occurs and the reaction potential.

9. A method according to any preceding claim in which the electrodes are made of one of gold or platinum.

10. A method according to any preceding claim in which the electrolyte is adjacent the membrane surface and the working electrode is as close as possible to the membrane surface to enable the optimum response to changes in the carbon dioxide gas concentration impinging on the other side of the membrane.

11. Gas detection apparatus comprising a housing made of non-electrically conducting material and having a permeable membrane adapted so that gas to be detected is urged therethrough from one side of the membrane to the other side, means for holding a volume of aqueous electrolyte on the other side of the membrane, electrodes positioned within the electrolyte volume adapted to have a potential difference applied therebetween and means to measure, in use of the application, an electric current passing between the electrodes.

12. Apparatus according to claim 11 in which the membrane acts in conjunction with the housing to keep the electrolyte in place.

13. Apparatus according to claim 11 or claim 12 in which the membrane is stretch fitted across an open end of the housing and secured in place with suitable fitting component(s).

14. Apparatus according to any one of claims 11 to 13 in which the electrodes are supported on a suitable non-electrically conducting substrate.

15. Apparatus according to claim 14 in which the electrodes are formed on the substrate by printing techniques.

16. Apparatus according to claim 14 or claim 15 in which the electrode substrate is porous to allow electrolyte to permeate through the pores to and from an electrolyte reservoir on the side of the substrate remote from the membrane.

17. Apparatus according to claim 16 in which the substrate is formed from a porous, sintered body or from an apertured sheet material.

18. Apparatus according to any one of claims 14 to 17 in which the working electrode comprises a number of “micro” or “point” electrodes formed in the substrate in a circular or line array.

19. Apparatus according to any one of claims 11 to 18 in which the electrodes are formed in a single plane as an array of interleaved concentric annular portions.
